(19) United States
(12) Patent Application Publication
(10) Pub. No.: US 2009/0149154 A1
(43) Pub. Date: Jun. 11, 2009

(54) METHOD FOR INTELLIGENT DATA HANDLING FOR MOBILE CALL BILLING USING IMS

(75) Inventors: Rohit Bhasin, Southampton (GB); Martin Gale, Eastleigh (GB)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/953,383

(22) Filed: Dec. 10, 2007

(51) Int. Cl. H04M 15/00

(52) U.S. Cl. 455/406

(57) ABSTRACT

A method for billing mobile device calls and traffic data, the method includes: receiving a number, in response to a user's input into a mobile communications device; comparing the received number to a contact list with annotations; determining whether the received number corresponds to a number in the contact list with annotations; generating a directed communication in response to the received number; sending a corresponding annotation to a billing system in response to the determining, and the initiation of the directed communication; wherein the mobile communication device generates the contact list with annotations, in response to the user input on a mobile communication device; and wherein the contact list and annotations are placed in a storage medium within the mobile communication device.

### BACKGROUND OF THE INVENTION

1. Field of the Invention

This invention relates generally to communication via electronic devices, and more particularly to a method for intelligent billing of mobile call and data traffic.

2. Description of the Related Art

Mobile communication devices, such as cellular phones, have become a central communication tool for both business and personal use. Competitive pressures and multiple billing options have lowered the subscriber cost of operation of mobile communication devices. In many instances, the mobile or cellular phone has replaced the traditional landline phone as a person's primary communication device. Advanced mobile communication devices offer not only voice services, but also text messaging and Internet access. Video and gaming applications are also now available on many mobile devices and service networks.

### SUMMARY OF THE INVENTION

Embodiments of the present invention include a method for billing mobile device calls and traffic data, the method includes: receiving a number, in response to a user's input into a mobile communications device; comparing the received number to a contact list with annotations; determining whether the received number corresponds to a number in the contact list with annotations; generating a directed communication in response to the received number; sending a corresponding annotation to a billing system in response to the determining, and the initiation of the directed communication; wherein the mobile communication device generates the contact list with annotations, in response to the user input on a mobile communication device; and wherein the contact list and annotations are placed in a storage medium within the mobile communication device.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, a solution is technically achieved for a method and system for intelligent data handling of billing data for mobile or cellular communication devices utilizing features of Internet protocol (IP) multimedia subsystems (IMS), or similar data networks.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a system for implementing embodiments of the invention.

FIG. 2 illustrates a flow chart for intelligent data handling of billing data for mobile or cellular communication devices utilizing features of Internet protocol (IP) multimedia subsystem (IMS), or similar data networks, according to embodiments of the invention.

FIG. 3 illustrates a mobile communication device with a screen displaying an exemplary phone book according to embodiments of the invention.

### The detailed description explains the preferred embodiments of the invention, together with advantages and features, by way of example with reference to the drawings.

### DETAILED DESCRIPTION

The widespread adoption of mobile communication devices has led to a significant increase in use of mobile devices for the purpose of business communications. However, as a result there is an increasing problem of employees making personal calls using their business mobile communication devices, or placing business calls on personal mobile communication devices. The monthly bill for communication services delivered to the customer details all calls and services, however it is left to the customer to differentiate and separate their personal calls and services, and charge the business calls to the company, or the business to charge personal calls to the employee. The process of dividing personal and business calls is tedious, time consuming, and error prone. An existing solution in place requires a user to prefix calls and then trace those prefixes once the detailed list appears on a monthly bill. However, this existing solution is also user dependent, and manual.

Embodiments the invention address the aforementioned billing problem of distinguishing between personal and business use, by annotating an address book on a mobile phone, where the annotation may be encoded and broadcast when a call is made. The annotation is decoded at the service provider end, and the calls are split into personal and business calls on the monthly bill based on the annotation. Embodiments of the invention provide an automated process that saves time, and accurately distinguishes between business and personal charges with minimal user error and user interference. Embodiments of the invention may utilize the Internet protocol (IP) multimedia subsystem (IMS) platform, or similar data networks. IMS is an architectural framework for delivering internet protocol (IP) multimedia to mobile users.

In embodiments of the invention, a user maintains a local address book of contacts in their mobile phone or communications device. The contacts are annotated to indicate whether they are a business or personal contact. The annotation of contacts may be accomplished manually, or in more sophisticated embodiments, by some automated means, for example, by means of an artificial intelligence rule that denotes a contact as personal, if they are typically called outside pre-defined business hours. Furthermore, in embodiments of the invention, the mobile phone or communication device has an Internet connection, such as over a 3G (third generation) network, or General Packet Radio Service (GPRS). GPRS is a Mobile Data Service available to users of Global System for Mobile Communications (GSM). GPRS may be used for services such as Wireless Application Protocol (WAP) access, Short Message Service (SMS), Multimedia Messaging Service (MMS), and for Internet communication services such as email and World Wide Web access.

In embodiments of the invention, in response to a subscribing user placing a call or utilizing a data service, a determining component in the mobile device performs a lookup in the mobile device's local address book, and determines whether the call or data service is being placed to a business or personal contact. If the call or service is business related (or conversely personal), a notification is sent over a transmission control protocol/Internet protocol (TCP/IP) network to the call service provider in parallel with the call or service. The notification provides sufficient information for the service provider to correlate the physical call or service with the notification (e.g., a timestamp and target telephone number). It is noted that the notification may be slightly delayed, in embodiments of the invention, until the call or service is actually accepted by a called party or their receiving communication device. In embodiments of the invention, the service provider correlates the received notification with the billing call record. Subsequently, the billing call record is annotated with a flag indicating the nature of the call or service (business or personal). The service provider may either tale the approach of assuming all calls or services are business, unless told otherwise (to flag calls or services to numbers not in the address book), or personal, depending on the nature of the user's service contract. Finally, the service provider provides a usage summary to a subscriber with business (or personal) calls or services annotated for identification. The usage summary may be further divided between personal and business use. In the event that the billing information is supplied to the subscriber in electronic form, the subscriber may perform various sorting of the billing information based on the annotations.

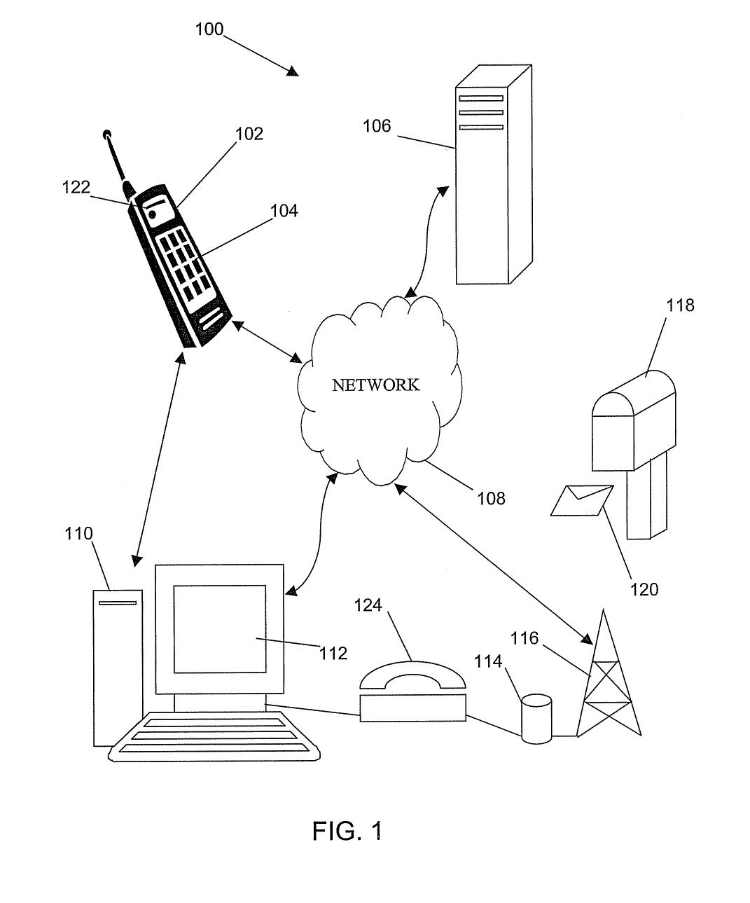

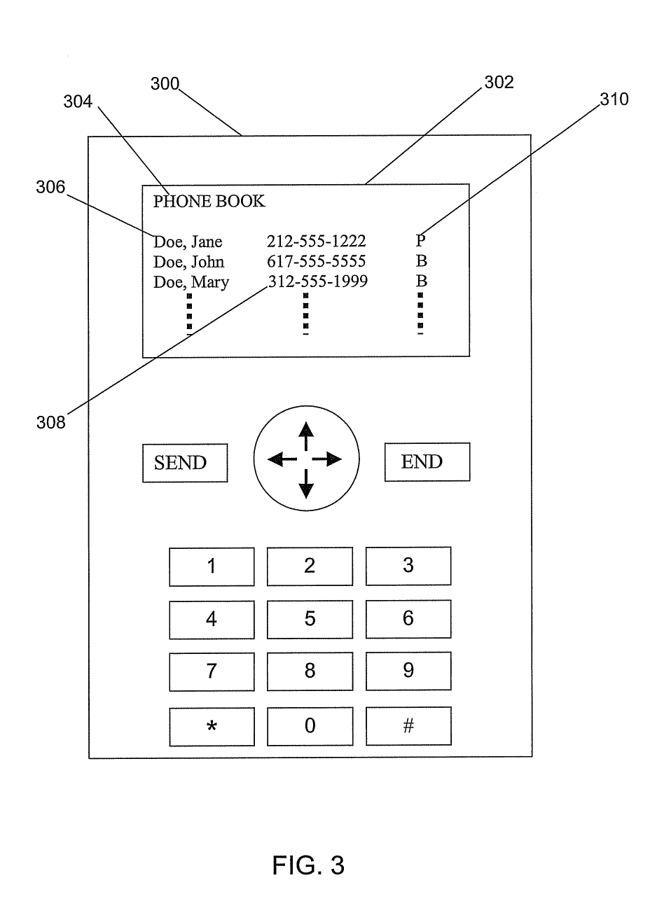

FIG. 1 illustrates a system 100 for implementing embodiments of the invention. A mobile communication device 102 with an alphanumeric keypad 104 and display screen 122 is utilized to place a wireless call or initiate a service over a communication network 108. The communication network 108 may be any known wireless network, or Internet enabled network. The mobile communications device 102 (shown in greater detail in FIG. 3) has a local address book (phone book) that is annotated to identify either business or personal contacts in the display screen 122. Cellular communications are signified by base station 114 and antenna 116 in electrical signal communication with the mobile communication device 102 and a central billing and subscriber records server 106 via network 108, and a public switched telephone network (PSTN) 124. Annotation information is sent, to the central billing and subscriber records server 106, by the mobile communication device 102 via the communications network 108. The subscriber records server 106 correlates the annotation information with network usage time determined by the cellular base station 118, and the phone number selected for initiating the call or service to delineate a billing summary. The delineated billing summary may be issued in written form as signified by letter 120 and mailbox 118, or delivered electronically to a subscriber computer 110, and displayed on screen 112. The computer 110 is connected to the network 108 or the PSTN 124. The subscriber based on the annotations may sort the electronic bill on their computer 110.

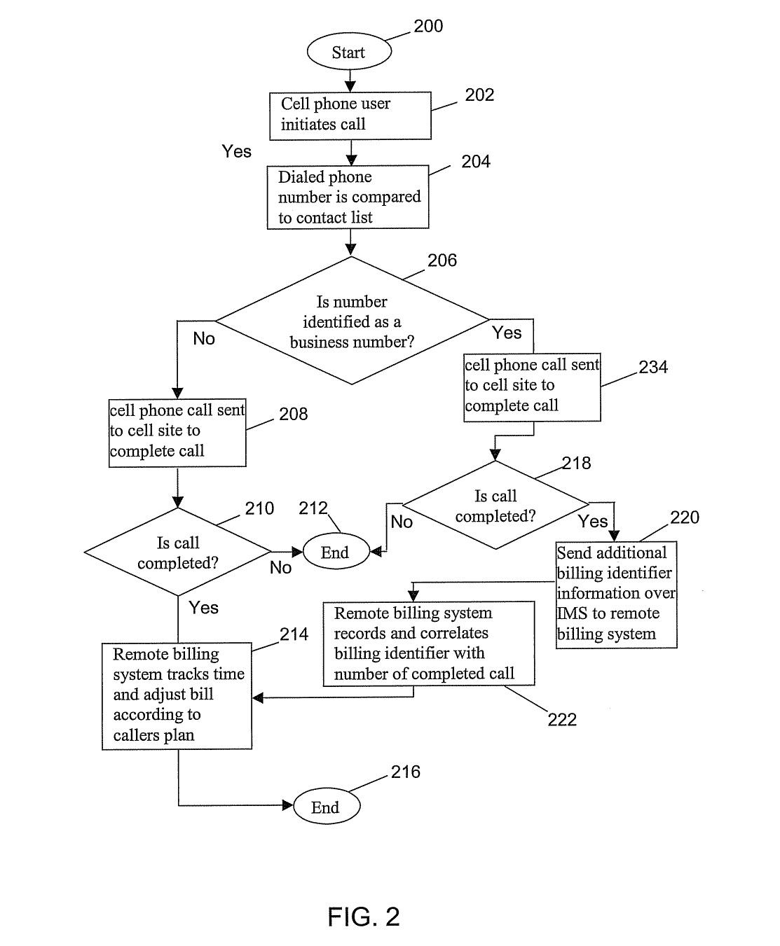

FIG. 2 illustrates a flow chart for intelligent data handling of billing data for mobile or cellular communication devices utilizing features of Internet protocol (IP) multimedia subsystem (IMS) according to embodiments of the invention. The process starts (block 200) with a cell phone user initiating a call (block 202). The dialed call number is automatically compared to a contact list (block 204) stored in the cell phone's memory to determine if the call is a business or personal call (decision block 206). If the dialed number is determined not to be a business call (decision block 206 is No), the cell phone call is sent to a receiving cell site (block 208). If the call is not completed (decision block 210 is No) the process ends (block 212). If the call is completed (decision block 210 is Yes), a remote billing system tracks time and adjusts the bill according to callers plan (block 214), and the process ends (block 216) when the call ends.

Continuing with FIG. 2, if the dialed number is determined to be a business call (decision block 206 is Yes), the cell phone call is sent to a receiving cell site (block 208). If the call is not completed (decision block 218 is No) the process ends (block 212). If the call is completed (decision block 218 is Yes), additional billing identifier information is sent over an IMS or similar network to a remote billing system (block 220). The remote billing system records and correlates the billing identifier with the number of the completed call (block 222), and the remote billing system tracks time and adjusts the bill according to callers plan (block 214), and the process ends (block 216) when the call ends.

FIG. 3 illustrates a mobile communication device 300 with a screen 302 displaying an exemplary phone book 304 according to embodiments of the invention. The mobile communication device's 300 phone book 304 is organized in memory in a database format, and displayed on the screen 302 in a series of columns. The first column 306 is an alphabetical list of names of stored contacts. The second column 308 has the corresponding contact numbers, and the third column 310 has the annotation identifiers for personal (P) or business (B) contacts. As described earlier, the annotation identifier is sent via an IMS, or similar data transmission means, to a service provider to assist in call categorization and billing preparation.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for billing mobile device calls and traffic data, wherein the method comprises:
receiving a number, in response to a user's input into a mobile communications device;
comparing the received number to a contact list with annotations;
determining whether the received number corresponds to a number in the contact list with annotations;
generating a directed communication in response to the received number;
sending a corresponding annotation to a billing system in response to the determining, and the initiation of the directed communication;
wherein the mobile communication device generates the contact list with annotations, in response to the user input on a mobile communication device; and
wherein the contact list and annotations are placed in a storage medium within the mobile communication device.

2. The method of claim 1, wherein the annotations delineate between business and personal communications.

3. The method of claim 2, wherein the billing system divides a billing statement based on the annotations; and
wherein the billing statement is sent by at least one of: electronically and in written form to the user; and
wherein the electronically sent billing statement is further sortable by the user.

4. The method of claim 1, wherein the sending of the annotations to the billing system is sent over Internet protocol (IP) multimedia subsystems (IMS).

5. The method of claim 1, wherein the directed communications are carried out on a Global System for Mobile Communications (GSM) network.
